(19) United States
(12) Patent Application Publication
(10) Pub. No.: US 2025/0117210 A1
(43) Pub. Date: Apr. 10, 2025

(54) ASSET SAFETY DATA MANAGEMENT

(71) Applicant: Honeywell International Inc., Charlotte, NC (US)

(72) Inventors: Yadunandan Belur Chandrashekar, Bangalore (IN); Girish Babu Venkatasubbarao, Bangalore (IN); Nivas Sekar, Bangalore (IN); Alok Gautam, Saharsa (IN); Satrujeet Dey, Bangalore (IN)

(21) Appl. No.: 18/792,615

(22) Filed: Aug. 2, 2024

Related U.S. Application Data
(60) Provisional application No. 63/542,527, filed on Oct. 5, 2023.

(51) Int. Cl. G06F 8/65

(52) U.S. Cl. CPC G06F 8/65

(57) ABSTRACT

Techniques for asset safety data management are described. In one example implementation, the present subject matter facilitates in managing updates in configuration data of the asset in the industrial environment. In an example, managing updates in the configuration data includes retrieving safety related data of the processing facility from the user in a preset format and generating the configuration data file based on the retrieved safety related data.

### BACKGROUND

Processing facilities, such as an industrial environment, are often managed using process and safety control systems. Example processing facilities include, but are not limited to, manufacturing plants, chemical plants, crude oil refineries, and ore processing plants. Among other operations, process and safety control systems typically manage the use of industrial equipments in the processing facilities. To enable efficient working of the processing facilities, configuration data files of the process and safety control systems are generated for safety analysis.

### SUMMARY

This summary is provided to introduce concepts related to managing asset safety data that are used in an industrial environment. This summary is not intended to identify essential features of the claimed subject matter nor is it intended for use in determining or limiting the scope of the claimed subject matter.

In an aspect of the present subject matter, a method for generating a configuration data file for process safety analysis using asset and attribute data is disclosed. The method includes receiving asset and attribute data corresponding to each of a plurality of assets operating in an industrial environment in a first data file of a first preset format. The asset and attribute data include attribute values for each of the plurality of assets. Further, the method includes generating a second data file utilizing the received asset and attribute data. The second data file includes cause and effect data corresponding to each of the plurality of assets, and the cause and effect data include relation data corresponding to relationships between cause and effect for each of the plurality of assets. The second data file is in a second preset format. Upon having the first data file and the second data file, the method further includes generating a configuration data file for process safety analysis by populating the attribute values from the first data file and the relationships from the second data file.

In another aspect of the present subject matter, a system for generating a configuration data file for process safety analysis using cause and effect data is disclosed. The system includes a file generation engine to receive cause and effect data corresponding to each of a plurality of assets operating in an industrial environment in a first data file of a first preset format. The cause and effect data include relationships between cause and effect of each of the plurality of assets. Further, the file generation engine generates a second data file utilizing the received cause and effect data. The second data file includes the asset and attribute data corresponding to each of the plurality of assets, and the asset and attribute data include attribute values for each of the plurality of assets. The second data file has a second preset format. The file generation engine further generates a configuration data file for process safety analysis by populating the relationships from the first data file and the attribute values from the second data file.

In yet another aspect of the present subject matter, a non-transitory computer readable medium for generating a configuration data file for process safety analysis using cause and effect data is disclosed. The non-transitory computer readable medium has instructions stored thereon. The instructions, when executed by a processor, cause the processor to perform operations. In the operations, cause and effect data corresponding to each of a plurality of assets operating in an industrial environment is received in a first data file of a first preset format. The cause and effect data include relationships between cause and effect of each of the plurality of assets. Further, in operation, a second data file is generated utilizing the received cause and effect data. The second data file includes the asset and attribute data corresponding to each of the plurality of assets, and the asset and attribute data include attribute values for each of the plurality of assets. The second data file has a second preset format. Further, in operation, a configuration data file is generated for process safety analysis by populating the relationships from the first data file and the attribute values from the second data file.

### BRIEF DESCRIPTION OF FIGURES

Systems and/or methods, in accordance with examples of the present subject matter are now described and with reference to the accompanying figures, in which:

FIG. 1 illustrates a system for generating a configuration data file in a processing facility of an environment, according to an example;

FIG. 2 illustrates a network environment for generating a configuration data file in a processing facility of an environment, according to an example;

FIG. 3 illustrates a flowchart of a method for generating a configuration data file in a processing facility of an environment, according to an example;

FIG. 4 illustrates a flowchart of receiving a first data file in a processing facility of an environment, according to an example;

FIG. 5 illustrates a flowchart of generating a second data file based on a first data file, according to an example;

FIG. 6 illustrates a flowchart of determining a file generation setting, according to an example;

FIG. 7 illustrates a flowchart of a method for generating a configuration data file in a processing facility of an environment, according to another example; and

FIG. 8 illustrates a system environment implementing a non-transitory computer readable medium for generating a configuration data file in a processing facility of an environment, according to an example.

### DETAILED DESCRIPTION

Typically, processing facilities, such as an industrial environment, are managed by a process and safety control system that controls assets or processes and ensures that the assets or the processes operate safely in the processing facilities. In an example, an asset may be an industrial equipment. A process may be a series or set of predefined or undefined steps carried out by the one or more such industrial equipment either independently or in combination with one or more such industrial equipment, operating in the processing facilities. In a processing facility, after operating over a period of time, a configuration data file of the process and safety control system needs to be updated to ensure seamless operational safety of the processing facility. Generally, the configuration data file is manually updated where a user of the processing facility needs to update the configuration data file by consolidating data with appropriate context from different systems like Safety System, Safety Life Cycle Management Tool, Field Device Manager etc. In an example, the data includes, but is not limited to, asset model, safety instrumented function relationships, and safety related alarm and event signatures. The safety instrumented function relationships include safety system cause and effect and safety life cycle management tool. The safety related alarm and event signatures include processed sub-set of events journals of the safety system. Such data are customer specific, so the user, for example, an individual of a project team, needs to interact with every new customer to obtain the data, manually process the same for a couple of weeks to build a right configuration data file for the processing facility's safety analysis, that can be loaded to take the system online for comprehensive safety analysis. However, manually obtaining the data and manually processing the obtained data is time consuming. In addition, the processing may be error prone due to involvement of manual steps. Also, collecting configuration data (cause and effect matrix, asset attribute with corresponding field tags) using their data collection sheets from customers/sites and further using these input collection sheets for manually creating process safety analyzer configuration file and then loading it is extremely manual, tedious, and time consuming.

The present subject matter provides approaches for asset safety data management. In an example, the present subject matter facilitates in managing updates in configuration data of the asset in the industrial environment. In an example, managing updates in the configuration data includes retrieving safety related data of the processing facility from the user in a preset format and generating the configuration data file based on the retrieved safety related data. The subject matter further facilitates improved collaboration and automating the configuration data file creation accurately and efficiently.

In an example, cause and effect data of the asset of the processing facility may be retrieved from the user in a first data sheet of the preset format. The term “data sheet” can be referred to as “data file” and can be interchangeably used hereinafter. In one example, the cause and effect may correspond to an asset or an asset type, and may include but is not limited to, an input or set of data, i.e. “cause”, which may be received by any system of the processing facility for any given asset or asset type of the processing facility, and causes the system of the processing facility to start off a set protocol which is to be followed in case of detection of the “cause” and carry out the necessary set of actions, i.e. “effects”, based on the set protocol which is to be followed for the corresponding assets or asset types of the processing facility.

Based on the retrieved cause and effect data, asset and attribute data may be generated in a second data sheet. The asset and attribute data may correspond to an asset or asset type and may include data which is associated with identifying the assets or asset type for which cause and effect data sheet has been provided and further includes describing or quantifying the properties associated with the asset or asset type and may include the corresponding field tag. Further, the first data sheet having the cause and effect data and the second data sheet having the asset and attribute data may be utilized to generate the configuration datafile. After receiving the first data sheet, further processing may be executed by an auto-setting.

In an example, asset and attribute data of the asset of the processing facility may be retrieved from the user in the first data file of the preset format. Based on the retrieved asset and attribute data, cause and effect data can be generated in the second data file. Further, the first data file having the asset and attribute data and the second data file having the cause and effect data may be utilized to generate the configuration data file. After receiving the first data file, further processing may be executed by an auto-setting.

In an example, the user may be a configuration user. The asset may be one of the industrial equipment, such as a boiler operating in an oil and gas plant and the process, such as a welding process operating in a vehicle manufacturing plant. Further, in an example, environment may be the processing facility, such as the industrial environment. The auto-setting may be defined as a setting as per which any process step may be automatically executed without requiring any user intervention. In an example, the configuration data file may be one of a dataset, a database in the form of a structured query language (SQL) file, a SQL file and an IDBA file. In an example, the configuration data file may be in a tabular format.

Accordingly, the present subject matter ensures that data collection sheets (either having asset and attribute data or cause and effect data), where either of the two data collection sheets may be received from the client in the preset format to generate the other data sheet, can be used to generate the configuration data file (bulk load file of the process safety analyzer) automatically. To generate the configuration data file automatically, bare minimum data is required. For example, if the customer has provided only cause and effect data, consolidated asset and attribute data can be automatically generated and further shared to the customers to get right field tags. Furthermore, the configuration file can be automatically generated using the cause and effect data and the asset and attribute data. Similarly, if the customer has provided only asset and attribute data, cause and effect data can be generated automatically and shared to the customers to get the relationship between causes and effects. Furthermore, the configuration file can be automatically generated using the cause and effect data and the asset and attribute data. Accordingly, the present subject matter, not only provides more flexibility by generating the configuration data file from only one input data file (which may contain cause and effect data or asset and attribute data), but also ensures that the configuration data file is generated in an automated manner.

The present subject matter enables bidirectional conversion between input collection file and the configuration data file for enabling the safety configuration enablement efficiently. The present subject matter further aims to streamline the process of updating and managing safety data, thereby enhancing the efficiency and accuracy of safety analyses in processing facilities. By automating the configuration data file generation process, the technology reduces the time and effort involved in managing safety data. It also minimizes the risk of human error, ensuring that the data used for safety analysis is accurate and reliable. Furthermore, this provides flexibility by allowing the generation of the configuration data file from either cause and effect data or asset and attribute data, thereby accommodating different starting points and data availability scenarios.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

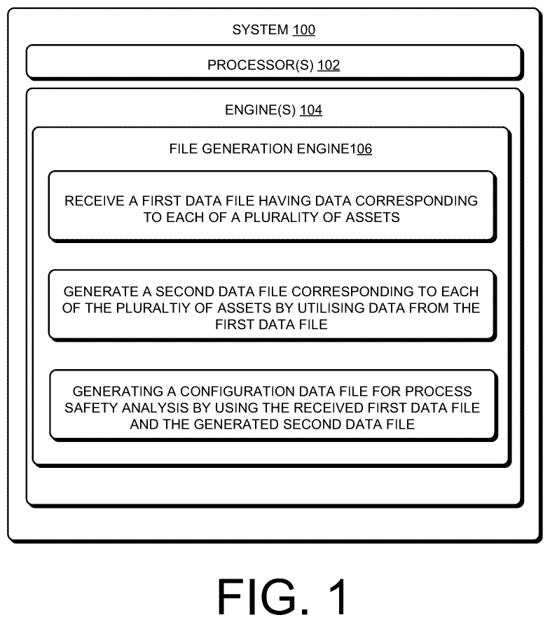

FIG. 1 illustrates a system 100 for updating configuration of an asset in a configuration data file of the asset, according to an example. Examples of the system 100 may include, but are not limited to, a laptop, a notebook computer, a server computer, a tablet computer, a mainframe computer, a distributed computing system, a grid computing system, a client server computing system, an edge computing system and a smartphone. The system 100 may include processor(s) 102. The processor(s) 102 may include microprocessors, embedded processors, microcomputers, microcontrollers, digital signal processors, central processing units, state machines, logic circuitries, and/or any other devices that may manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 may be capable of delivering applications (such as cloud applications) for managing an industrial environment. The cloud-based applications being delivered by the system 100 may include user interactive interfaces, where the user interactive interfaces may include, but are not limited to, Descriptive Iconography, Command-Line Interfaces (CLIs), Graphic User Interfaces (GUIs), etc. The user interactive interface may benefit a user of system 100 by allowing better monitoring and control operations in both real time processing scenarios and offline batch processing scenarios. The system 100 may also be capable of interacting with one or more other systems which are operating in the same processing environment or some other separate processing environment. The separate processing environment may be within the geographical vicinity of the processing environment of the system 100 or beyond the geographical vicinity of the processing environment of the system 100. The system 100 may perform interactions with the separate system of the separate processing environment, in a bidirectional manner and may include sharing or retrieving data for achieving better operational parameters and performance characteristics for either of the systems.

The system 100 may also be capable of delivering Real-Time Operating Systems (RTOs) which are highly beneficial for time critical applications like industrial control systems. The Real-Time Operating Systems (RTOs) may enable the system to perform tasks and operations within a specified time limit, relaxed time limit, predictable time limit, etc.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. In another example, the engine(s) 104 may also be capable of generating a customizable virtual machine, where the customizable virtual machine may be a computer resource which functions like a physical computer and is capable of performing various tasks associated with the functionality of the engine(s) 104 for the system 100. The customizable virtual machine may have the potential to handle, monitor and perform all operational tasks associated with the system 100 in the processing environment. The entire operational tasks associated with the system 100 may be handed over to the generated customizable virtual machine for complete or partial automation of the system 100 of the processing environment. The engine(s) 104 includes a file generation engine 106 and may include other engines.

In an example, the asset may be one of an industrial equipment, such as a boiler operating in an oil and gas plant or a desalter in a hydro-skimming plant. In an example, the asset may be one of a process, such as a welding process operating in a vehicle manufacturing plant or a milling process operating in a fabrication plant. Examples of industrial equipment may include, but is not limited to, relief valves, blowdown valves, dampers, breakers, pressure plates, temperature sensors, feeders, air dryers, and filters. An existing configuration of an asset may be a vendor provided parameter on which the asset may operate safely. This vendor provided parameter may be decided based on various testing methodologies which may be performed at the time of the manufacturing of the asset or may be based on real-time random experimentation or any other method of evaluation capable of deciding the parameters under which the asset may operate safely. The vendor provided parameter may be limited by international or domestic industry standards. For example, in case the asset is an intake valve of a boiler, the intake valve is to be closed after 10 minutes of starting of any process taking place in the boiler for ensuring safe operation of the boiler may be decided as per a usage manual of the intake valve, 10 minutes may then be considered as the configuration of the intake valve. In another example, in case the asset is the process involving a heavy weight used for milling of wheat in a food processing plant, the heavy weight may be moved by a gear in a grinding rotational motion at 10 revolutions per minute (RPM) for half an hour as per an operating manual of the food processing plant, for achieving the desired particle size of the grain, 10 RPM for half an hour may then be considered as the configuration of the heavy weight milling process of the food processing plant.

In an example, an update in the configuration data file may be to update the operational parameter of the asset so as to monitor if the asset is safely operated within the operational parameter as per the predefined configuration. In an example, an update in the configuration data file may be to update the data corresponding to pre-existing operational parameter data of the asset with latest data so as to monitor if the asset is safely operated as per the pre-defined configuration. In an example, an update in the configuration data file may be to fill the missing data which may otherwise be not present due to any given irregularity, so as to monitor if the asset is safely operated as per the pre-defined configuration. In an example, an update in the configuration data file may be to obtain correct data corresponding to an identified incorrect data which may be present due to any given irregularity and replacing the incorrect data with the correct data so as to monitor if the asset is safely operated as per the pre-defined configuration. In an example, an update in the configuration data file may be to transform the data corresponding to an operational parameter of the asset of the system 100. The data transformation may include but is not limited to, converting data into another format, structure or set of values and may include processes such as normalization, standardization, discretization, encoding, etc. to allow for a more detailed, systematic and rational analysis and monitoring of the operational parameter of the asset, and to assess if the asset is safely operated as per the predefined configuration of the operational parameter. The data transformation may also involve application of various mathematical or non-mathematical formulae and logic on the data associated with the operational parameter of an asset for automatically deriving results which may not be present in the system 100 initially, thereby allowing the system 100 to automatically self-generate the required data. For creating the configuration data file of assets involved in an industrial setup, two data sheets may be required. One data sheet may include data related to cause and effect of the asset and another sheet may include data related to attributes of the asset.

With the implementation of the present subject matter, either of the data sheet may be used to generate the other data sheet and further both the data sheets can be used to generate the configuration data file. The term “data sheet” can be referred to as “data file” and can be interchangeably used hereinafter. In an example, with the implementation of the present subject matter, a completely filled either of the data sheet may be used to generate a completely filled other data sheet and both the data sheets may be used to generate the configuration file. In an example, with the implementation of present subject matter, a partially filled data sheet may be used to generate a completely filled other data sheet, by first populating the partially filled data sheet with relevant data in the required format which may be a preset format, and then generating the completely filled other data sheet using the completely filled first data sheet and further both the sheets may then be used to generate the configuration data file.

An example of Cause and Effect Matrix in case of an intake valve as the asset may be based on an operation of the asset when the intake valve must get closed based on a sensor input, for example, when the boiler pressure is higher than a predefined safety threshold.

Another example of the Cause and Effect Matrix in case of a fan as the asset may be based on an operation of the asset when the fan must start rotating based on a sensor input, for example, when the ventilation system air flow is lower than a predefined threshold.

In an example, a safety logic implemented in an LPG storage may be illustrated for the Cause and Effect Matrix, where fire sensors mounted on the LPG Storage will be acting as the “Causes” and these are interfaced to Safety System via Input Sub System, the moment Safety System detects the fire signal or the “Cause”, it executes a control logic and generate commands or “Effects” to turn off the control valve supplying the gas from that storage and opening a water sprinkle valve on the top of the storage unit to create a safe water curtain.

In an example, a preventive/guardian reasoning circuitry or control system and computing logic implemented in synchronous manner in a nuclear power plant may be illustrated for the cause and effect matrix, where temperature and pressure sensors mounted on the nuclear reactors will be acting as the “Causes” and are interfaced to the preventive/guardian reasoning circuitry or control system and computing logic via a sub circuitry or separate computing logic. The moment the preventive/guardian reasoning circuitry or control system and computing logic detects increased temperature and pressures corresponding to the nuclear reactor, it executes a sequential series of steps or “Effects” to turn on the reactor cooling system and open respective pressure valves for safe operation of the nuclear reactor and prevent a nuclear meltdown.

In an example, the data related to assets and their attributes may be linked to a specific asset or a category of assets in the asset and attribute data sheet. This data may include information that helps in identifying the assets or the category of assets for which the cause and effect data sheet may been given or may be required to be generated. This data may describe or quantify the properties associated with the asset or asset type and may allow describing or measuring the characteristics related to the asset or the category of assets. The data may also contain the corresponding field tag.

In an example, the asset and attribute data sheet may be a record that includes, but is not limited to, a catalog of assets for which cause and effect data sheet may have been provided or is required to be generated. In an example, the asset and attribute data sheet may be a record that includes, but is not limited to, attribute data where the attribute data may contain specific pieces of information associated with the properties or characteristics of the asset. In an example, this may include, but is not limited to, operational parameter limits of the asset or the asset category, model number of the asset or the asset category, purchase date and make of the asset or the asset category, total working hours of the asset or asset category, colour of the asset or asset category, and other such information.

In an example implementation for a manufacturing plant's conveyor belt. The attribute data for this conveyor belt may include, but is not limited to, its model number, manufacturing date, last service date, modulus of elasticity, etc. and may further include the corresponding field tag which may be a unique identifier for the particular asset or asset category such as the conveyer belt as mentioned above. The corresponding field tag may include, but is not limited to, an RFID tag, a barcode, NFC, QR code, etc. This data helps in identifying and understanding the asset or the asset category in detail.

In an example operation, the file generation engine 106 of the system 100 may initially receive a first data file. The first data file contains the asset and attribute data corresponding to a plurality of assets in an industrial environment. The first data file may be in a required format which may be a first preset format and contains attribute values. In an example, the first data file containing the asset and attribute data corresponding to the plurality of assets in the industrial environment may be an Excel Spreadsheet. The first data file thus contains the asset and attribute data containing the attribute values corresponding to each of the plurality of assets. The file generation engine 106 may read the shutdown group information for cause and effect and populate in a shutdown group sheet in the configuration file along with some default seed data.

In an example, the first data file may contain a plurality of fields which may contain the attribute data for each of the plurality of assets and where the corresponding fields may be predefined for the plurality of assets. In an example, the asset may be a dehumidifier and the predefined fields corresponding to the attributes of the dehumidifier may include, but is not limited to, the pint capacity of the dehumidifier, the collection tank capacity, air flow rate, specific coverage area. The first data sheet may have fields which are marked essential and are compulsory to be filled by the user manually or may be filled using an auto-setting. In an example, the first data sheet may have fields which are marked optional and may not be filled by the user or via auto-setting. In an example, the first data sheet may identify and highlight the fields which correspond to assets which are more prone to faults and errors and exhibit non-ideal behaviour more frequently.

In an example, the first data file may be filled by the user. In another example, the first data file may be filled by the user by fetching data from a master data sheet where the master data sheet may contain the asset and attribute data for each of the plurality of assets. In an example, the first data sheet may be filled by the system 100 by using data from a master sheet entirely automatically.

In an example, the system 100 may employ techniques including but not limited to, web scraping, document parsing, text extraction, Application Programme Interface (API) extraction, etc. for filling the first data sheet in case one or more attribute values are missing for any of the asset of the plurality of assets. In an example, the first data sheet may be filled by a customizable virtual machine generated by the system 100 where the customizable virtual machine may be a computer resource which functions like a physical computer and is capable of performing various tasks associated with the functionality of the engine(s) 104 for the system 100. The customizable virtual machine may auto generate or self-generate data corresponding to operational characteristics of one or more assets by using techniques, including but not limited to, machine learning, large language models, rules-based functions, observational study, randomized experimentation, etc to populate the first data sheet in case one or more attribute values are missing for any of the asset of the plurality of assets.

The first data file received by the file generation engine 106 may thus be filled or populated by user operated means, system operated means or by means of the generated virtual machine for complete filling of the first data file either in a manual, semi-automated or completely automated manner.

Upon receiving the first data file containing the asset and attribute data, the file generation engine 106 of the system 100 may generate a second data file by utilizing the received asset and attribute data. The generated second data file may include cause and effect data corresponding to each of the plurality of assets. The file generation engine 106 may analyse the attribute values for each of the assets, identify potential causes and effects based on these values, and generate the second data file with this cause and effect data. In an example, the generation of the second data file may include determining assets which are essentially to be analyzed. The assets which are essentially to be analyzed may be the assets which will require prior attention in case of a non-ideal behavior of the system 100 in a processing environment. The file generation engine 106 may first fill or populate data corresponding to these essential assets in cases of emergency. The generation of the second data file from the complete or partially filled first data file can be done by retrieving the attribute data which may already be present or be generated in case of its absence. The generated second data file may be partially or completely filled based on the requirement of the system 100 operating in the processing environment. The assets and their retrieved attributes are thus populated by the file generation engine 106 in a file termed above as the second data file.

The cause and effect data of the generated second data file may include relation data corresponding to relationships between the cause and effect for each of the plurality of assets. The generated second data file may be in a required format which may be a second preset format.

In an example, the generation of the second data file may include analyzing the first data file for each of the plurality of assets for which the attributes values are indicated in the first data file. Further, from the first data file, the cause and effects are grouped based on the shutdown group they belong to in the industrial environment, and the retrieved cause and effects are populated by the file generation engine 106 in a file termed as a second data file.

In an example, for the plurality of assets from the first data file, the cause and effect data may be generated by using a configuration generation tool which converts the asset and attribute data to the second file containing the cause and effect data. In an example, the generation of the second data file may include analyzing the first data file to determine the attribute values and consequently generating the second data file if the first data file is completely filled and all details of attribute values are present for each of the plurality of assets. In an example, the generation of the second data file may include analyzing the first data file to determine assets for which no attribute value has been provided and is missing due to some irregularity or discrepancy which may include human error. Further, for such assets the file generation engine 106 may populate the fields for which the attribute values are missing in the first data file, by using one or more data generating techniques which may include, but is not limited to deep learning, neural network, machine learning techniques, etc. Once the first data file is completely populated and contains attribute values for each of the plurality of assets, the file generation engine 106. In an example, for such assets where the attribute values are missing for one or more of the plurality of assets in the first data file, the file generation engine 106 may populate the fields for which the attribute values are missing in the first data file, by retrieving from the master data file data pertaining to attributes for all the assets of the industrial environment. Once the first data file is completely populated and contains attribute values for each of the plurality of assets, the file generation engine 106 generates the second data file.

The attribute values corresponding to such assets which have missing attribute values in the first data file may also be auto generated by system 100 for the file generation engine 106 in cases of extreme emergencies where there are chances of catastrophic failure of the processing facility. In scenarios where even the master sheet does not contain the attribute data pertaining to an asset the generation of the attribute data in such scenarios can be done by using techniques which include but are not limited to using vectors and embeddings, query models, indexing paradigms, data classification, history and cache searching, web crawling and scraping, synthetic data generation, etc.

Further, during the operation, once the first and the second data files are available and the first and the second data sheets are obtained, the file generation engine 106 of the system 100 may utilize the first data file and the second data file as input files to generate the configuration data file for a process safety analysis. The file generation engine 106 may populate all the data of the first data file and the second data file in a further file called as the configuration data file.

In an example, the configuration data file may be a bulk load data file that includes the configuration data of each of the assets and processes operating in the environment. The configuration data file may be generated by populating the attribute values from the first data file and the relationships from the second data file. The configuration data file may serve as a comprehensive record of the asset and attribute data and the cause and effect data for each of the plurality of assets operating in the industrial environment. This configuration data file may be used for various purposes, such as safety analysis, process optimization, and other operational tasks.

In an example, the configuration data file may be one of a dataset, a database in the form of a structured query language (SQL) file, a SQL file, and an IDBA file. These formats may be chosen based on the specific requirements of the industrial environment and the system's data processing capabilities. For instance, a SQL file may be used if the system is designed to work with relational databases, while an IDBA file may be used if the system is designed to work with object-oriented databases.

In an example, the configuration data file may be in a tabular format. This format may allow for efficient organization and presentation of the data, facilitating subsequent analysis and processing. The tabular format may include rows corresponding to the plurality of assets and columns corresponding to the attribute values and the relationships. This format may provide a clear and concise overview of the asset and attribute data and the cause and effect data for each of the plurality of assets.

While the figures have been mainly described with reference to an asset, the present subject matter may be similarly implemented for different processes being executed in the facility.

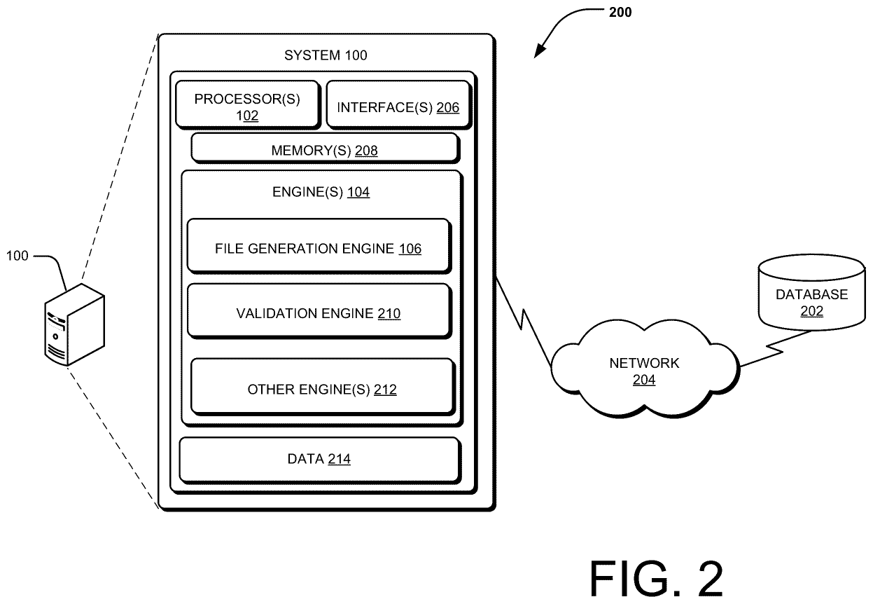

FIG. 2 illustrates a network environment 200 for configuration of an asset in a configuration data file of the asset, according to an example. The network environment 200 includes the system 100 for updating configuration of the asset in the configuration data file of the asset. In an example, the system 100 may be connected to a database 202 through a network 204. The database 202 may be, for example, a structured query language (SQL) data store or a not only SQL (NoSQL) data store. In an exemplary implementation, the database 202 may be configured as cloud-based database implemented in the industrial environment. In another exemplary implementation, the database 202 may be a location on a file system directly accessible by the engines. The database 202 may be configured to store engineering project files, program files, object behavior model, parameter values associated with the one or more assets, cause and effect data, asset and attributes data, processes and the like.

The network 204 may be a wireless network, a wired network, or a combination thereof. The network 204 can also be an individual network or a collection of many such individual networks, interconnected with each other and functioning as a single large network, e.g., the Internet or an intranet. The network 204 can be implemented as one of the different types of networks, such as intranet, local area network (LAN), wide area network (WAN), the internet, and such. The network 204 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 may be a company network, including thousands of office personal computers, laptops, various servers, such as blade servers, and other computing devices connected over the network 204. The system 100 includes the processor(s) 102. Further, the system 100 includes interface(s) 206 and memory(s) 208. The interface(s) 206 may allow the connection or coupling of the system 100 with one or more other devices, through a wired (e.g., Local Area Network, i.e., LAN) connection or through a wireless connection (e.g., Bluetooth®, Wi-Fi). The interface(s) 206 may also enable intercommunication between different logical as well as hardware components of the system 100.

The memory(s) 208 may be a computer-readable medium, examples of which include volatile memory (e.g., RAM), and/or non-volatile memory (e.g., Erasable Programmable read-only memory, i.e., EPROM, flash memory, etc.). The memory(s) 208 may be an external memory, or internal memory, such as a flash drive, a compact disk drive, an external hard disk drive, or the like. The memory(s) 208 may further include data which either may be utilized or generated during the operation of the system 100.

The system 100 may further include the engine(s) 104 and data 214. The engine(s) 104 includes the file generation engine 106, a validation engine 210, and other engine(s) 212. The other engine(s) 212 may further implement functionalities that supplement functions performed by the system 100 or any of the engine(s) 212. In one example, the other engine(s) 212 may include a download engine (not shown). In one example, the other engine(s) 212 may include a display engine (not shown) and a download engine (not shown). The data 214, on the other hand, includes data that is either stored or generated as a result of functions implemented by any of the engine(s) 104 or the system 100. It may be further noted that information stored and available in the data 214 may be utilized by the engine(s) 104 for performing various functions by the system 100. In an example, the data 214 may include cause and effect data, asset and attribute data, historic operational data, configuration file data, and other data. It may be noted that such examples are only indicative. The present approaches may be applicable to other examples without deviating from the scope of the present subject matter.

In an example operation, the file generation engine 106 of the system 100 may receive asset and attribute data corresponding to each of a plurality of assets operating in an industrial environment in a first data file of a first preset format. The asset and attribute data include attribute values for each of the plurality of assets. The first preset format is a format compatible with the processor 102 and readable by the processor 102. In an example, the environment may be a process facility, such as an industrial environment and is similar to the environment of FIG. 1. Example processing facilities include, but are not limited to, manufacturing plants, chemical plants, crude oil refineries, and ore processing plants. In one example, the file generation engine 106 may obtain information pertaining to the asset and attribute data from the database 202. In an example, an empty data file may be downloaded in the first preset format. The download may be an auto-download or may be a manually prompted download. Further, the cause and effect data may be populated in the empty data file from a master data file to generate the first data file. The master data file may be associated to the database 202 and contains all the information relevant to the industrial environment. In an example, the first preset format has cause and effect template. In an example, the second preset format has asset and attribute template. In an example, the first data file includes predefined fields corresponding to the cause and effect data of each of the plurality of assets.

In one example, the file generation engine 106 of the system 100 may further determine a file generation setting of the configuration data file. The file generation setting may be one of a manual file generation setting and an auto file generation setting. The manual file generation setting may be defined as a setting as per which a user input may be required to execute any process step. The auto file generation setting may be defined as a setting as per which any process step may be automatically executed without requiring any user intervention. In one example, the file generation engine 106 may generate a second data file utilizing the received asset and attribute data on receiving a first prompt from a user when the file generation setting is determined as the manual file generation setting. In one example, the file generation engine 106 may auto generate the second data file utilizing the received asset and attribute data when the file generation setting is determined as the auto file generation setting. The second data file includes cause and effect data corresponding to each of the plurality of assets. The cause and effect data may include relation data corresponding to relationships between cause and effect for each of the plurality of assets. The second data file may be generated in a second preset format. The second preset format is a format compatible with the processor 102 and readable by the processor 102. In one example, the second file may be generated based on analysis of the first file. For generating the second data file, the file generation engine 106 may analyze the first data file. The analysis of the first data file is performed to determine the assets actuated attributes indicated in the first data file. Such an analysis helps in filtering out the assets to be taken into account for further considerations. For the assets resulted based on the analysis, the file generation engine 106 may determine effects that may result for the determined assets from the master data file having data pertaining to effects for all the assets operating in the industrial environment. Further, the file generation engine 106 may populate the determined causes and the effects for the determined assets in the second data file. In an example, the file generation engine 106 may determine position of an initiator designating cause tags and a final element designating effect tags from the first data file and accordingly determines the assets for which the attributes are to be retrieved. That is, the asset is determined based on the position of the initiator and the final element. The file generation engine 106 further populate data corresponding to effects value of the determined asset in the second data file. In an example, the first data file may be analyzed to determine effects designating the attribute values indicated in the first data file and further causes for the determined effects are determined from a master data file having data pertaining to causes for all the assets operating in the industrial environment. Post that, the determined causes and the effects for the determined causes may be populated in the second data file. In an example, the first data file and the second data file are input data files.

The validation engine 210 of the system 100 may validate that essential effect values are filled in the second data file. The validation process is a file structure validation process. The essential effects values are those identified as relevant to the assets being functional as per the first data file. To further validate the second data file, it may be determined if the second data file includes minimum predefined parameters of effect values of each of the plurality of relevant assets. In one example, every asset has a minimum set of parameters of effect specified by the vendor of the asset or the manufacturer of the asset that are mandatory to be verified for the operational check of the asset. In an example, minimum predefined parameters may be minimum parameters such as safety devices operational setting change or relationship between safety inputs with safety operation, interdependency with safety logic grouping. In case some essential effect values are determined as missing in the second data file, the validation engine is to update the second data file by populating effect values not filled in the second data file.

In an example, the second data file may be validated to determine compatibility of the second data file. In an example implementation, the compatibility determination is a basic sanity check that may be performed to ascertain that the the second data file is processable by the system 100. In one example, the second data file may be validated by a preliminary check to verify that the second data file is in a predefined format. In an example, predefined format may be a structure of the file. In one example, if the system 100 accepts files in PDF format, then the predefined format is the PDF format. Examples of the predefined format includes, but is not limited to, a PDF format and an excel format. In one example, the predefined format may be a size of the second data file. For example, if any data file is larger than 100 MB but smaller than 150 MB may be of a predefined format. Examples of the predefined format is not limited to the size of the data file, other parameters may also be considered to define the predefined format of the data file. In an example, similar validation may be performed in the first data file.

When the first data file and the second data file are available for further processing, the validation engine 210 may determine if the first data file and the second data file include minimum predefined parameters for the generation of the configuration data file. On determining that the first data file and the second data file include minimum predefined parameters for the generation of the configuration data file, the generation of the configuration data file is further processed. In case of determining that the first data file and the second data file do not include the minimum predefined parameters, the validation engine 210 may generate a diagnostic report indicating missing predefined parameters. In an example, the diagnostic report may indicate missing predefined parameters of the first data file and the second data file. In an example, based on the generated diagnostic report, the first data file and the second data file may be updated to include the missing predefined parameters in the first data file and the second data file. The first data file and the second data file inclusive of the parameters which were missing earlier can be revalidated to determine if the updated the first data file and the second data file include minimum predefined parameters of configuration data of each of the plurality of assets. The validated the first data file and the second data file may then be utilized for the configuration file generation.

In an example, in the auto file generation setting, the file generation engine 106 may pick one of the asset and attribute data file and the cause and effect data file from a database where the one of the asset and attribute data file and the cause and effect data file is stored after being received. In an example, the pick of the data files from the database may be done by a conventionally known technique. In an example, the user may be a configuration user. In an example, the user may feed one of the asset and attribute data file and the cause and effect data file for the generation of the configuration data file.

Further, the file generation engine 106 generates a configuration data file for process safety analysis by populating the attribute values from the first data file and the relationships from the second data file. The configuration data file may be a bulk load data file that includes the configuration data of each of the assets and processes operating in the environment. The configuration data includes data of asset-attributes and cause-effects. In an example, the configuration data file may be generated either on receiving a second prompt from the user in case the file generation setting is determined as the manual file generation setting or may auto generate the configuration data file utilizing the received asset and attribute data when the file generation setting is determined as the auto file generation setting. In an example, the first data file may include predefined fields corresponding to the cause and effect data of each of the plurality of assets that enables the file generation engine 106 to generate the data as per the requirement by generating the asset and attribute data of each of the plurality of assets based on the predefined fields corresponding to the cause and effect data of each of the plurality of assets. In an example, the file generation engine 106 may generate unique default values and further generates the unique default values in the configuration data file.

In an example, the validation engine 210 may further generate a diagnostic report upon determining that the configuration data file does not include the minimum predefined parameters. In an example, the diagnostic report may indicate missing predefined parameters of configuration data. In an example, based on the generated diagnostic report, the configuration data file may be updated to include the missing predefined parameters of configuration data. The configuration data file inclusive of the parameters which were missing earlier can be revalidated to determine if the updated configuration data file includes minimum predefined parameters of configuration data of each of the plurality of assets. The validated configuration data file may then be utilized for the configuration file generation.

In an example, the file generation engine 106 may store the configuration data file in a high-performance data structure having one or more dictionaries. Upon storing the configuration data file in the high-performance data structure, the file generation engine 106 may monitor one or more of modified properties and non-modified properties of each of the plurality of assets operating in the industrial environment based on the one or more dictionaries. Each dictionary has a key as string which determines the property name in the sheets and has a value as a complex type keeping track of all the values. This data structure is uniformly used across all of the sheets for tracking change information and later used to generate parameters which are candidates for reanalyzing. Due to the data structure, anytime a new sheet can be accommodated with any number of properties in the file generation engine 106. Moreover, the present invention ensures that any change is not required for accommodating new sheet as this is driven from the backend data structure entirely. The configuration data file is described as being stored in the high-performance data structure having one or more dictionaries. However, the configuration data file could be stored in various ways. For example, the configuration data file could be stored in a relational database, a NoSQL database, a flat file, or a cloud-based data storage system. The configuration data file could also be stored in memory for fast access. The choice of data storage method could affect the speed, scalability, and reliability of data access.

In another example operation, the file generation engine 106 of the system 100 may receive cause and effect data corresponding to each of a plurality of assets operating in an industrial environment in a first data file of a first preset format. The cause and effect data include relationships between cause and effect of each of the plurality of assets. The first preset format is a format compatible with the processor 102 and readable by the processor 102. In an example, the environment may be a process facility, such as an industrial environment and is similar to the environment of FIG. 1. Example processing facilities include, but are not limited to, manufacturing plants, chemical plants, crude oil refineries, and ore processing plants. In one example, the file generation engine 106 may obtain information pertaining to the asset and attribute data from the database 202. In an example, an empty data file may be downloaded in the first preset format. The download may be an auto-download or may be a manually prompted download. Further, the cause and effect data may be populated in the empty data file from a master data file to generate the first data file. The master data file may be associated to the database 202 and contains all the information relevant to the industrial environment. In an example, the first preset format has cause and effect template. In an example, the second preset format has asset and attribute template. In an example, the file generation engine 106 may further read the cause and effect relationship marked with some identification recognizable by a computing unit and populate the cause and effect sheet. For example, an intersection of cause and effects with an identification mark indicates the relationship between the cause and effects. For each intersection, a row may be created in a configuration data file part having cause and effect sheet along with this some default seed data read from a configuration data file template. In addition, some unique default values are created by the file generation engine 106 may also be populated. Further, all the cause initiators and effect initiators from the cause and effects may be read and populated in the configuration data file part having an asset and attribute sheet along with some default seed data read from the configuration file template and populated further.

In one example, the file generation engine 106 of the system 100 may further determine a file generation setting of the configuration data file. The file generation setting may be one of a manual file generation setting and an auto file generation setting. The manual file generation setting may be defined as a setting as per which a user input may be required to execute any process step. The auto file generation setting may be defined as a setting as per which any process step may be automatically executed without requiring any user intervention. In one example, the file generation engine 106 may generate a second data file utilizing the received cause and effect data on receiving a first prompt from a user when the file generation setting is determined as the manual file generation setting. In one example, the file generation engine 106 may auto generate the second data file utilizing the received cause and effect data when the file generation setting is determined as the auto file generation setting. The second data file includes asset and attribute data corresponding to each of the plurality of assets. The asset and attribute data may include attribute values for each of the plurality of assets. The second data file may be generated in a second preset format. The second preset format is a format compatible with the processor 102 and readable by the processor 102. In one example, the second file may be generated based on analysis of the first file. For generating the second data file, the file generation engine 106 may analyze the first data file. The analysis of the first data file is performed to determine the assets actuated based on the effects indicated in the first data file. Such an analysis helps in filtering out the assets to be taken into account for further considerations. For the effects resulted based on the analysis, the file generation engine 106 may determine assets for the determined effects from the master data file having data pertaining to effects for all the assets operating in the industrial environment. Further, the file generation engine 106 may populate the determined assets and the attributes for the determined assets in the second data file. The file generation engine 106 further populate data corresponding to attribute value of the determined asset in the second data file.

The validation engine 210 of the system 100 may validate that essential attribute values are filled in the second data file. The essential attribute values are those identified as relevant to the assets being functional as per the first data file. To further validate the second data file, it may be determined if the second data file includes minimum predefined parameters of attribute values of each of the plurality of relevant assets. In one example, every asset has a minimum set of parameters of attribute data specified by the vendor of the asset or the manufacturer of the asset that are mandatory to be verified for the operational check of the asset. In an example, minimum predefined parameters may be minimum parameters such as safety devices operational setting change or relationship between safety inputs with safety operation, interdependency with safety logic grouping. In case some essential attribute values are determined as missing in the second data file, the validation engine is to update the second data file by populating attribute values not filled in the second data file.

In an example, the second data file may be validated to determine compatibility of the second data file. In an example implementation, the compatibility determination is a basic sanity check that may be performed to ascertain that the the second data file is processable by the system 100. In one example, the second data file may be validated by a preliminary check to verify that the second data file is in a predefined format. In an example, predefined format may be a structure of the file. In one example, if the system 100 accepts files in PDF format, then the predefined format is the PDF format. Examples of the predefined format includes, but is not limited to, a PDF format and an excel format. In one example, the predefined format may be a size of the second data file. For example, if any data file is larger than 100 MB but smaller than 150 MB may be of a predefined format. Examples of the predefined format is not limited to the size of the data file, other parameters may also be considered to define the predefined format of the data file. In an example, similar validation may be performed in the first data file. In an example, various methods may be used to validate the data. For example, the data could be validated using statistical methods, machine learning algorithms, or rule-based systems. The data may also be validated through user confirmation or through comparison with a master data file. The choice of data validation method may affect the reliability and accuracy of the data.

Further, the file generation engine 106 generates a configuration data file for process safety analysis by populating the attribute values from the first data file and the relationships from the second data file. In an example, the configuration data file may be generated either on receiving a second prompt from the user in case the file generation setting is determined as the manual file generation setting or may auto generate the configuration data file utilizing the received asset and attribute data when the file generation setting is determined as the auto file generation setting. In an example, the first data file may include predefined fields corresponding to the cause and effect data of each of the plurality of assets that enables the file generation engine 106 to generate the data as per the requirement by generating the asset and attribute data of each of the plurality of assets based on the predefined fields corresponding to the cause and effect data of each of the plurality of assets.

In an example, asset and attribute data or cause and effect data may be received from a user. However, these data could be collected in various ways. For example, the data could be automatically collected from sensors or other data sources in the industrial environment. The data could also be collected through user input, such as through a graphical user interface or a command-line interface. The data could also be imported from other systems or databases. The choice of data collection method could affect the accuracy, timeliness, and completeness of the data.

In an example implementation, the system 100 may be a process safety analyzer. The process safety analyzer is a suite of a shutdown analyzer and a safety element scout application. The shutdown analyzer and the safety element scout application are used to safely control the assets and contain the processes in the industrial environment, referred to as plant hereinafter in this paragraph. The process safety analyzer is used to verify whether the process plant shutdown sequences and safety elements are functioning as expected. A plant historian provides history for both events and process data and extracts the data from a variety of systems across multiple levels to quickly form a complete context of a manufacturing environment in the plant. The data collected in the plant historian is periodically monitored by process safety analyzer and is updated as per the present subject matter for the safe and efficient control and operation of the assets and the processes in the plant.

Although the first and second data files, as well as the configuration data file are described as being in a preset format, these files could be in various formats depending on the specific requirements of the industrial environment and the system's data processing capabilities. For example, the data files could be in a CSV (Comma Separated Values) format, a JSON (JavaScript Object Notation) format, an XML (extensible Markup Language) format, or any other suitable data file format. The choice of format could affect the ease of data manipulation, the compatibility with other systems, and the efficiency of data processing.

In an example operation, the file generation engine 106 of the system 100 may receive an input file having cause and effect instance filled from a user. In an example, the use may be a customer. The file generation engine 106 further finds the position of the initiator and final element from a cause and effect (C&E) file (Information Sheet). For example, CauseTag Header cell (not shown and may be vertical values in a table) are initiators, and EffectTag Header cell (not shown and may be horizontal values in a table) may be final element. Further, the file generation engine 106 may populate the data in an asset and attribute (A&A) template. Action, Asset, Location, SD Group Column headers are predefined in the A&A Template. file generation engine 106 further read all the assets configured in the C&E (Vertical Values below CauseTag Header) and populate in the Asset Column in an initiator Sheet, read all the assets configured in the C&E (Horizontal values after the EffectTag Header cell) and populate in an asset column in a final element sheet. The corresponding values from the Location and SDGroups are also read from the C&E and populated in the A&A template. Further, the configuration data file (Process Safety Analyzer PSA Template) has all the list of attributes that are supported for Initiator Asset (Cause) and Final Element Equipment (Effect), and Basic Attribute list has the mandatory Attributes list that needs to be filled by User. Using PSA Template and Basic Attribute List, all the Attributes are populated in the Asset Attribute List and the Mandatory Attributes are highlighted with a color.

In case the asset and attribute sheet is filled by the user or the customer, the cause and effect data file can be generated in the manner as generated in FIG. 1 by the system 100. Further, during the operation, the file generation engine 106 of the system 100 may utilize the first data file and the second data file as input files (Cause and effect instance filled by the user and asset and attribute instance generated therefrom). The file generation engine 106 may validate if all the mandatory attribute values are filled. Further, the file generation engine 106 may populate all the data of the first data file and the second data file in a further file called as a configuration data file. The configuration file is a bulk load file.

In an example implementation, the system 100 may be a process safety analyzer. The process safety analyzer is a suite of a shutdown analyzer and a safety element scout application. The shutdown analyzer and the safety element scout application are used to safely control the assets and contain the processes in the industrial environment, referred to as plant hereinafter in this paragraph. The process safety analyzer is used to verify whether the process plant shutdown sequences and safety elements are functioning as expected. A plant historian provides history for both events and process data and extracts the data from a variety of systems across multiple levels to quickly form a complete context of a manufacturing environment in the plant. The data collected in the plant historian is periodically monitored by process safety analyzer and is updated as per the present subject matter for the safe and efficient control and operation of the assets and the processes in the plant.

In an example implementation, a client may provide a C&E Workbook (WB) and a project engineer generate a BLF (bulk load file, i.e., configuration data file), the BLF can be loaded to a PSA (process safety analyzer). The BLF can be used to generate A&A WB. The client provides updated A&A workbook, and the project engineer may use it to generate an updated BLF.

The present subject matter therefore ensures that the configuration of the asset is duly stored or updated in the configuration file so as to not compromise with the safety of the industrial environment. The system 100 of the present subject matter provides a robust and efficient approach to managing asset safety data in an industrial environment. By automating the generation of configuration data files for process safety analysis, the technology enhances the safety and operational efficiency of processing facilities. It is a valuable tool for safety professionals and facility managers who are responsible for maintaining high safety standards in complex industrial settings.

In addition, the present subject matter eliminates manual intervention of the user for creating the configuration file. Instead, the present subject matter is capable of working on auto-setting.

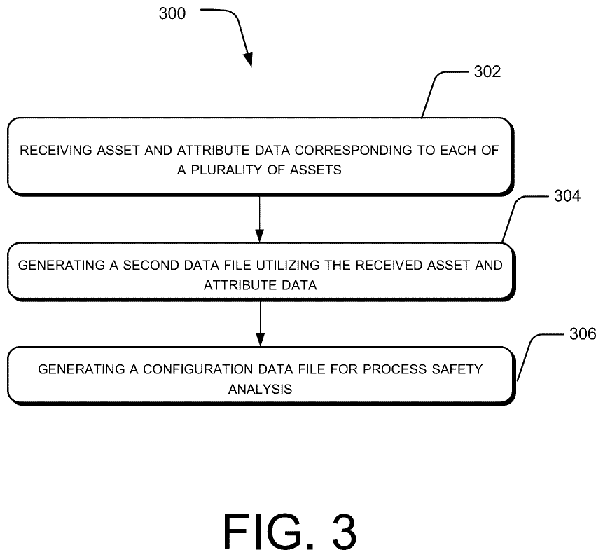

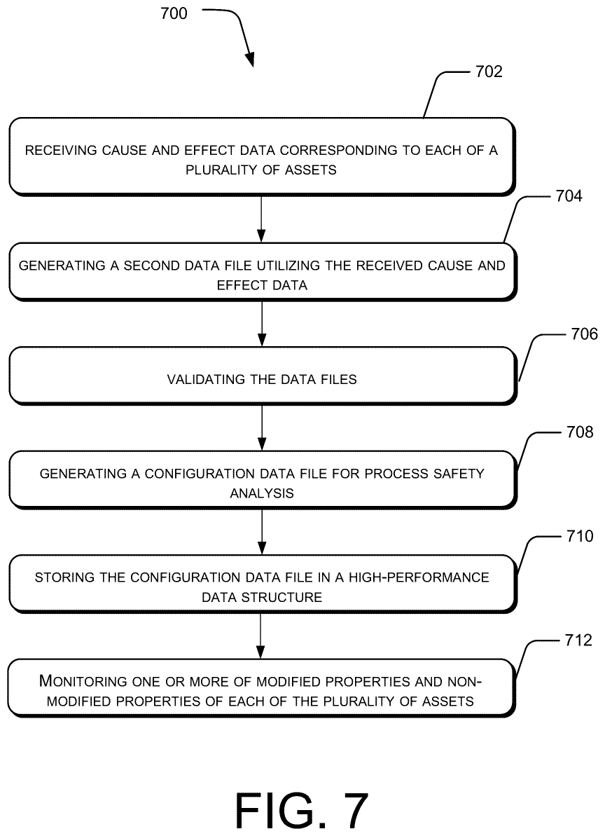

FIGS. 3 and 7 illustrate flowcharts of methods 300 and 700 for generating a configuration data file in a processing facility of an environment, according to an example. The order in which the above-mentioned methods are described is not intended to be construed as a limitation, and some of the described method blocks may be combined in a different order to implement the method, or an alternative method.

Furthermore, the above-mentioned methods may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods.

Referring to FIG. 3, the method 300 may be implemented by a system for for generating the configuration data file in the processing facility of the environment. The configuration data file may be similar to the configuration data file of FIG. 1.

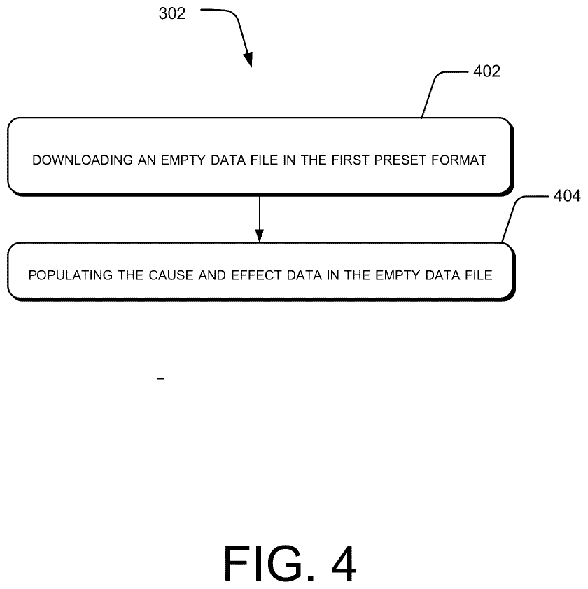

At block 302, the method includes receiving asset and attribute data corresponding to each of a plurality of assets operating in an industrial environment in a first data file of a first preset format. The asset and attribute data may include attribute values for each of the plurality of assets. The first preset format is a format compatible with the processor 102. In an example, the environment may be a process facility, such as an industrial environment and is similar to the environment of FIG. 1. The receiving of the asset and attribute data is shown in FIG. 4.

In FIG. 4, at block 402, the method includes downloading an empty data file in the first preset format. The download may be an auto-download or may be a manually prompted download. Further, at block 404, the method includes populating the cause and effect data in the empty data file from a master data file to generate the first data file. The master data file may be associated to a database similar to the database 202 of FIG. 2 and contains all the information relevant to the industrial environment. In an example, the first preset format has cause and effect template. In an example, the first data file includes predefined fields corresponding to the cause and effect data of each of the plurality of assets.

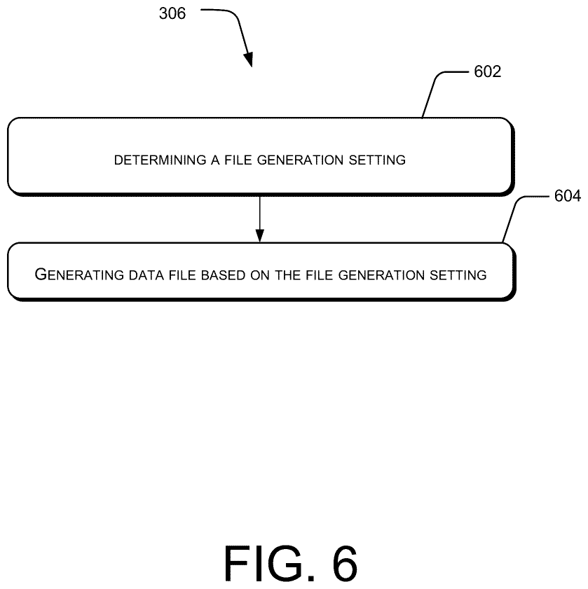

Returning to FIG. 3, at block 304, the method includes generating a second data file utilizing the received asset and attribute data. Prior to the generation of the second data file, a file generation setting of the configuration data file may be determined as illustrated in FIG. 6. In FIG. 6, at block 602, the method includes determining the file generation setting of the configuration data file. The file generation setting may be one of a manual file generation setting and an auto file generation setting. The manual file generation setting may be defined as a setting as per which a user input may be required to execute any process step. The auto file generation setting may be defined as a setting as per which any process step may be automatically executed without requiring any user intervention. The second data file may be generated based on the determined file generation setting and accordingly the configuration data file may be generated based on either the manual file generation setting or the auto file generation setting.

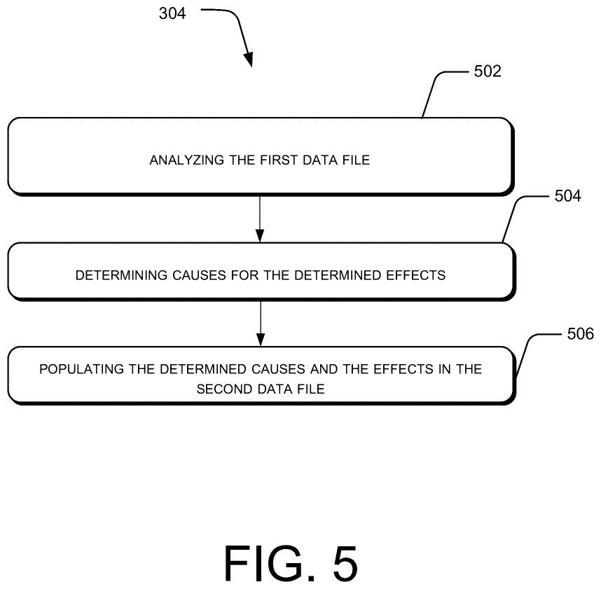

The generation of the second data file based on the first data file is illustrated in FIG. 5. In FIG. 5, at block 502, the method includes analyzing the first data file. The second data file includes cause and effect data corresponding to each of the plurality of assets. The analysis of the first data file is performed to determine the assets actuated attributes indicated in the first data file. For the assets resulted based on the analysis, effects may be determined that may result for the determined assets from the master data file having data pertaining to effects for all the assets operating in the industrial environment.

At block 504, the method includes determining causes for the determined effects, and at block 506, the method includes populating the determined causes and the effects for the determined assets in the second data file. The second data file may be generated in a second preset format. The second preset format is a format compatible with the processor. In an example, the first data file and the second data file are input data files.

Returning to FIG. 3, at block 306, the method includes generating a configuration data file for process safety analysis by populating the attribute values from the first data file and the relationships from the second data file. In an example, the first data file may include predefined fields corresponding to the cause and effect data of each of the plurality of assets that enables to generate the data as per the requirement by generating the asset and attribute data of each of the plurality of assets based on the predefined fields corresponding to the cause and effect data of each of the plurality of assets.

Further, FIG. 7, at block 702, the method includes receiving cause and effect data corresponding to each of a plurality of assets operating in an industrial environment in a first data file of a first preset format. The cause and effect data include relationships between cause and effect of each of the plurality of assets. The first preset format is a format similar to that of FIG. 3. In one example, the file generation engine 106 may obtain information pertaining to the asset and attribute data from the database 202. In an example, an empty data file may be downloaded in the first preset format. The download may be an auto-download or may be a manually prompted download. Further, the cause and effect data may be populated in the empty data file from a master data file to generate the first data file. The master data file may be associated to the database and contains all the information relevant to the industrial environment. In an example, the first preset format has cause and effect template.

At block 704, the method includes a second data file utilizing the received cause and effect data on receiving a first prompt from a user when the file generation setting is determined as the manual file generation setting. In one example, the second data file may be auto generated utilizing the received cause and effect data when the file generation setting is determined as the auto file generation setting. The second data file includes asset and attribute data corresponding to each of the plurality of assets. The asset and attribute data may include attribute values for each of the plurality of assets. The second data file may be generated in a second preset format. The second preset format is a format compatible with the processor, and the second file may be generated based on analysis of the first file. For generating the second data file, the first data file may be analyzed to determine the assets actuated based on the effects indicated in the first data file and for filtering out the assets to be taken into account for further considerations. Further, the determined assets and the attributes for the determined assets in the second data file may be populated.

At block 706, the method includes validating the data files (the first data file and the second data file). The essential effect values filled in the second data file may be validated. The essential effects values are those identified as relevant to the assets being functional as per the first data file. To further validate the second data file, it may be determined if the second data file includes minimum predefined parameters of effect values of each of the plurality of relevant assets. For example, every asset has a minimum set of parameters of effect specified by the vendor of the asset or the manufacturer of the asset that are mandatory to be verified for the operational check of the asset. In case some essential effect values are determined as missing in the second data file, the second data file may be updated by populating effect values not filled in the second data file. In an example, the second data file may be validated to determine compatibility of the second data file. In an example implementation, the compatibility determination is a basic sanity check. In one example, the second data file may be validated by a preliminary check to verify that the second data file is in a predefined format, for example, in PDF format.

In an example, when the first data file and the second data file are available for further processing, it may be determined by the validation if the first data file and the second data file include minimum predefined parameters for the generation of the configuration data file. On determining that the first data file and the second data file include minimum predefined parameters for the generation of the configuration data file, the generation of the configuration data file is further processed. In case of determining that the first data file and the second data file do not include the minimum predefined parameters, a diagnostic report indicating missing predefined parameters may be generated. In an example, the diagnostic report may indicate missing predefined parameters of the first data file and the second data file. In an example, based on the generated diagnostic report, the first data file and the second data file may be updated to include the missing predefined parameters in the first data file and the second data file. The first data file and the second data file inclusive of the parameters which were missing earlier can be revalidated to determine if the updated the first data file and the second data file include minimum predefined parameters of configuration data of each of the plurality of assets. The validated the first data file and the second data file may then be utilized for the configuration file generation.

After the validation, at block 708, the method includes generating a configuration data file for process safety analysis by populating the attribute values from the first data file and the relationships from the second data file. In an example, the configuration data file may be generated either on receiving a prompt from the user in case the file generation setting is determined as the manual file generation setting or may auto generate the configuration data file utilizing the received asset and attribute data when the file generation setting is determined as the auto file generation setting. In an example, a diagnostic report may also be generated upon determining that the configuration data file does not include the minimum predefined parameters and the configuration data file may then be updated and validated accordingly before utilized for the configuration file generation.

At block 710, the method includes storing the configuration data file in a high-performance data structure having one or more dictionaries. Upon storing the configuration data file in the high-performance data structure, one or more of modified properties and non-modified properties of each of the plurality of assets operating in the industrial environment may be monitored based on the one or more dictionaries as per block 712. Each dictionary has a key as string which determines the property name in the sheets and has a value as a complex type keeping track of all the values. This data structure is uniformly used across all of the sheets for tracking change information and later used to generate parameters which are candidates for reanalyzing. Due to the data structure, anytime a new sheet can be accommodated with any number of properties in the configuration data file. Moreover, the present invention ensures that no change is required for accommodating new sheets as this is driven from the backend data structure entirely.

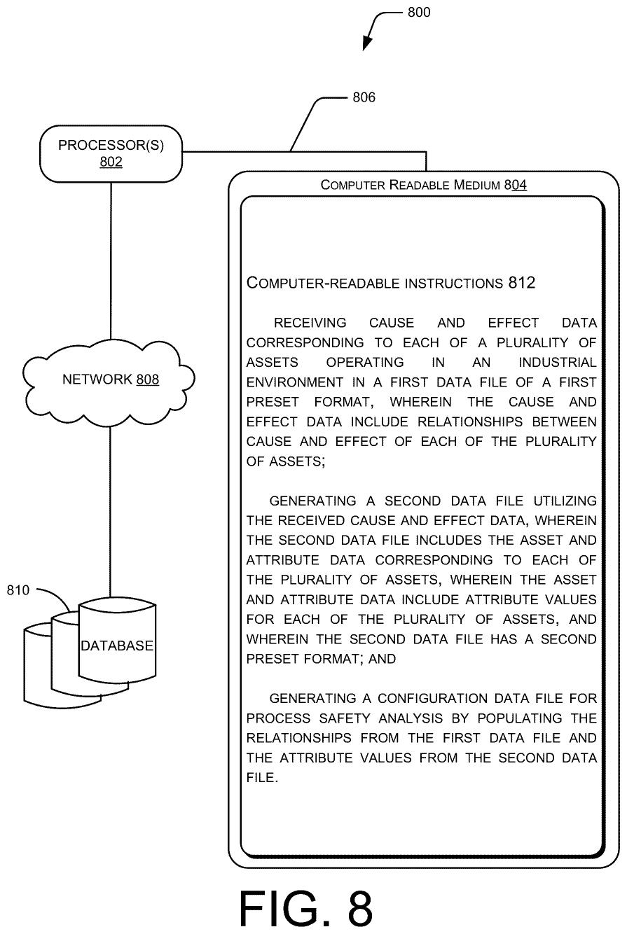

FIG. 8 illustrates a system environment 800 implementing a non-transitory computer readable medium for generating a configuration data file in a processing facility of an environment, according to an example. In an example, the system environment 800 includes processor(s) 802 communicatively coupled to a non-transitory computer readable medium 804 through a communication link 806. In an example, the processor(s) 802 may have one or more processing resources for fetching and executing computer-readable instructions from the non-transitory computer readable medium 804. The processor(s) 802 and the non-transitory computer readable medium 804 may be implemented, for example, in the system 100 (as has been described in conjunction with the preceding figures).

The non-transitory computer readable medium 804 may be, for example, an internal memory device or an external memory device. In an example implementation, the communication link 806 may be a network communication link. The processor(s) 802 may access the non-transitory computer readable medium 804 through a network 808. The network 808 may be a single network or a combination of multiple networks and may use a variety of communication protocols. The processor(s) 802 and the non-transitory computer readable medium 804 may also be communicatively coupled to a data source 810 over the network 808. The data source 810 may include, for example, a database.

In an example implementation, the non-transitory computer readable medium 804 includes a set of computer readable instructions (hereinafter may also be referred as instructions) 812 which may be accessed by the processor(s) 802 through the communication link 806. Referring to FIG. 8, in an example, the non-transitory computer readable medium 804 includes instructions 812 that may cause the processor(s) 802 to receive cause and effect data corresponding to each of a plurality of assets operating in an industrial environment in a first data file of a first preset format. The cause and effect data include relationships between cause and effect of each of the plurality of assets. The first preset format is a format compatible with the processor 802 and readable by the processor 802. In an example, the environment may be a process facility, such as an industrial environment. Example processing facilities include, but are not limited to, manufacturing plants, chemical plants, crude oil refineries, and ore processing plants. In one example, the file generation engine 106 may obtain information pertaining to the asset and attribute data from the database 810. In an example, the first preset format has cause and effect template.

Further, the instructions 812 may cause the processor(s) 802, to generate a second data file utilizing the received cause and effect data either automatically by an auto file generation setting or manually by a manual file generation setting. The second data file includes asset and attribute data corresponding to each of the plurality of assets. The asset and attribute data may include attribute values for each of the plurality of assets. The second data file may be generated in a second preset format. The second preset format is a format compatible with the processor 802 and readable by the processor 802.

Further, the instructions 812 may cause the processor(s) 802, to generate a configuration data file for process safety analysis by populating the attribute values from the first data file and the relationships from the second data file. In an example, the configuration data file may be generated either on receiving a prompt from a user in case the file generation setting is determined as the manual file generation setting or may auto generate the configuration data file utilizing the received asset and attribute data when the file generation setting is determined as the auto file generation setting. In one example, the second file may be generated based on analysis of the first file. For generating the second data file, the instructions 812 cause the processor 802 to analyse the first data file. The analysis of the first data file is performed to determine the assets actuated based on the effects indicated in the first data file. Such an analysis helps in filtering out the assets to be taken into account for further considerations. For the effects resulted based on the analysis, assets for the determined effects are determined from the master data file having data pertaining to effects for all the assets operating in the industrial environment. Further, the the determined assets and the attributes for the determined assets are populated in the second data file and further data corresponding to attribute value of the determined asset is populated in the second data file. Also, the instructions 812 cause the processor 802 to validate that essential attribute values are filled in the second data file. The essential attribute values are those identified as relevant to the assets being functional as per the first data file.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising
receiving asset and attribute data corresponding to each of a plurality of assets operating in an industrial environment in a first data file of a first preset format, wherein the asset and attribute data include attribute values for each of the plurality of assets;
generating a second data file utilizing the received asset and attribute data, wherein the second data file includes cause and effect data corresponding to each of the plurality of assets, wherein the cause and effect data include relation data corresponding to relationships between cause and effect for each of the plurality of assets, and wherein the second data file has a second preset format; and
generating a configuration data file for process safety analysis by populating the attribute values from the first data file and the relationships from the second data file.

2. The method as claimed in claim 1, wherein the receiving of the asset and attribute data comprises:
downloading an empty data file in the first preset format; and
populating the cause and effect data in the empty data file from a master data file to generate the first data file.

3. The method as claimed in claim 1, wherein the first data file comprises predefined fields corresponding to the cause and effect data of each of the plurality of assets.

4. The method as claimed in claim 1, wherein the generating of the second data file comprises,
analyzing the first data file to determine effects designating the attribute values indicated in the first data file; and
determining causes for the determined effects from a master data file having data pertaining to causes for all the assets operating in the industrial environment; and
populating the determined causes and the effects for the determined causes in the second data file.

5. The method as claimed in claim 4, further comprising validating the second data file to determine that all the effects corresponding to the determined assets are filled in the second data file.

6. The method as claimed in claim 1, wherein the first data file and the second data file are input data files.

7. The method as claimed in claim 1, wherein the generating of the configuration data file comprises:
determining a file generation setting of the configuration data file, the file generation setting being one of a manual file generation setting and an auto file generation setting;
for the file generation setting being the manual file generation setting, generating the second data file on receiving a first prompt from a user and further generating the configuration data file, based on the first data file and the second data file, on receiving a second prompt from the user; and
for the file generation setting being the auto file generation setting, auto generate the second data file and the configuration data file based on the first data file and the auto-generated second data file.

8. The method as claimed in claim 1, further comprising generating unique default values and populating the unique default values in the configuration data file.

9. The method as claimed in claim 1, further comprising:
storing the configuration data file in a high-performance data structure having one or more dictionaries; and
monitoring, based on the one or more dictionaries, one or more of modified properties and non-modified properties of each of the plurality of assets operating in the industrial environment.

10. The method as claimed in claim 1, further comprising validating the first data file and the second data file to determine compatibility of the first data file and the second data file for the generation of the configuration data file.

11. The method as claimed in claim 10, wherein the validating comprises:
determining if the first data file and the second data file include minimum predefined parameters for the generation of the configuration data file; and
upon determining that the first data file and the second data file do not include the minimum predefined parameters, generating a diagnostic report indicating missing predefined parameters.

12. A system comprising:
a file generation engine to:
receive cause and effect data corresponding to each of a plurality of assets operating in an industrial environment in a first data file of a first preset format, wherein the cause and effect data include relationships between cause and effect of each of the plurality of assets;
generate a second data file utilizing the received cause and effect data, wherein the second data file includes the asset and attribute data corresponding to each of the plurality of assets, wherein the asset and attribute data include attribute values for each of the plurality of assets, and wherein the second data file has a second preset format; and
generate a configuration data file for process safety analysis by populating the relationships from the first data file and the attribute values from the second data file.

13. The system as claimed in claim 12, wherein the file generation engine is to:
analyze the first data file to determine the assets actuated based on the effects indicated in the first data file; and
determine attributes for the determined assets from a master data file having data pertaining to attributes for all the assets operating in the industrial environment; and
populate the determined assets and the attributes for the determined assets in the second data file.

14. The system as claimed in claim 12, wherein the file generation engine is to:
determine position of an initiator designating cause tags and a final element designating effect tags from the first data file;
determine the asset based on the position of the initiator and the final element; and
populate data corresponding to attribute value of the determined asset in the second data file.

15. The system as claimed in claim 12, further comprising a validation engine to validate that essential attribute values are filled in the second data file.

16. The system as claimed in claim 15, wherein the validation engine is to update the second data file by populating attribute values not filled in the second data file.

17. The system as claimed in claim 12, wherein the first preset format has cause and effect template and the second preset format has asset and attribute template.

18. A non-transitory computer readable medium having instructions stored thereon, the instructions, when executed by a processor, cause the processor to perform operations comprising:
receiving cause and effect data corresponding to each of a plurality of assets operating in an industrial environment in a first data file of a first preset format, wherein the cause and effect data include relationships between cause and effect of each of the plurality of assets;
generating a second data file utilizing the received cause and effect data, wherein the second data file includes the asset and attribute data corresponding to each of the plurality of assets, wherein the asset and attribute data include attribute values for each of the plurality of assets, and wherein the second data file has a second preset format; and
generating a configuration data file for process safety analysis by populating the relationships from the first data file and the attribute values from the second data file.

19. The non-transitory computer readable medium as claimed in claim 18, wherein the generating of the second data file comprises,
analyzing the first data file to determine the assets actuated based on the effects indicated in the first data file; and
determining attributes for the determined assets from a master data file having data pertaining to attributes for all the assets operating in the industrial environment; and
populating the determined assets and the attributes for the determined assets n the second data file.

20. The non-transitory computer readable medium as claimed in claim 18, further comprising validating that essential attribute values are filled in the second data file.
